(19) United States
(12) Patent Application Publication
(10) Pub. No.: US 2014/0316812 A1
(43) Pub. Date: Oct. 23, 2014

(54) Patient Intake E-Registration

(71) Applicants: Joseph Turner Hathorn, Sugar Land, TX (US); Christopher Chi Yong Kwon, Katy, TX (US)

(72) Inventors: Joseph Turner Hathorn, Sugar Land, TX (US); Christopher Chi Yong Kwon, Katy, TX (US)

(21) Appl. No.: 14/258,838

(22) Filed: Apr. 22, 2014

Related U.S. Application Data
(60) Provisional application No. 61/815,244, filed on Apr. 23, 2013.

(51) Int. Cl. G06F 19/00

(52) U.S. Cl. CPC G06F 19/322; G06F 19/327
USPC 705/3

(57) ABSTRACT

Disclosed is a method of streamlining the intake registration of a patient at a healthcare provider facility. A secure, online database is provided via web-based interface portal for a patient to enter and store the patient's private health information (PHI) data. A unique readable scanning code, such as a QR code, is assigned to the patient's stored data. The scanning code is placed on items that may be carried by the patient, such as, wallet-sized cards, pendants, stickers, or via display on the patient's mobile devices or PC devices. The healthcare provider facility is provided with a scanner to read the QR code. The patient controls access to the PHI data via levels of security set by the patient. Upon entering the healthcare provider facility, the patient's QR code is scanned, and the permitted level(s) of PHI data are automatically populated into the facility's electronic health record system(s).

### CROSS-REFERENCE TO RELATED APPLICATIONS

This application claims the benefit of the filing date of and priority to U.S. Provisional Application Ser. No. 61/815,244 entitled “Patient Intake E-Registration” and filed Apr. 23, 2013, Confirmation No. 8481. This provisional application is incorporated by reference herein.

### STATEMENT REGARDING FEDERALLY SPONSORED RESEARCH OR DEVELOPMENT

Not Applicable.

### BACKGROUND OF THE INVENTION

### Field of the Invention

The present disclosure relates generally to the field of electronic storage of and access to patient medical records, and more particularly to the field of patient registration into a healthcare provider facility, particularly, an emergency room (“ER”) or hospital emergency department (“ED”).

Emergency departments across the US are under great strain as patient demand is continually rising and economic pressures mount. An unwelcome aspect of this is that patients are often required to wait for longer periods of time creating much dissatisfaction. Lengthy and complicated registration processes in most hospital ERs add to the frustration and often unnecessarily extend the patent waiting time.

Market Overview.

In 2011, the New York Times reported that hospital emergency rooms/departments are closing at an alarming rate. Over the last 20 years, urban and suburban areas have lost 25% of their hospital ER departments according to a study in The Journal of the American Medical Association. ER departments were more likely to close if they: served a large number of poor people; were part of a commercially operated hospital; were in hospitals with low profit margins; and were in highly competitive areas. Market forces are playing a larger role in the availability of care in the US. Many people are concerned that the distribution of ERs will not remain equitable. Many experts are concerned that conditions will worsen as the impact of the Affordable Health Care Act begins to be felt in the marketplace. (Rabin, Roni Caryn, “Fewer Emergency Rooms Available as Need Rises”, New York Times, May 17, 2011), http://www.nytimes.com/2011/05/18/health/18hospital.html?_r=0).

From 1990 to 2009, the number of hospital ERs in non-rural areas decreased from 2446 to 1779, a decline of 27%. Yet in this same period, ED visits increased by 30%, from 94.8 million visits to 123 million visits annually. (Hsia, R. Y., Kellermann, A. L., and Shen, Y. “Factors Associated With Closures of Emergency Departments in the United States”, Journal of the American Medical Association, May 18, 2011, http://jama.jamanetwork.com/article.aspx?articleid=1161864).

More recent data comes from a 2011 National Health Interview Survey. (Gindi, R. M, Cohen, R. A., and Kirzinger, W. K., “Emergency Room Use Among Adults Aged 18-64: Early Release of Estimates From The National Health Interview Survey, January-June 2011”, CDC, May 2012, http://www.cdc.gov/nchs/data/nhis/earlyrelease/emergency_room_use_january-june_{—}2011.pdf). This study was based on adults aged 18-64 whose last hospital visit did not result in a hospital admission and it provided the following results:
79.7% had no access to other providers while 66% had serious medical problems
Common reasons for an ER visit were:
   Only a hospital could help (54.5%)
   Doctor's office not open (48.0%)
   No other place to go (46.3%)
Adults with a public health plan were 2× more likely than those without insurance to visit an ER because their doctor's office wasn't open
Adults who were uninsured were more likely than those with insurance to visit the ER because they had nowhere else to go
Adults living outside a metropolitan statistical area (MSA) were more likely to visit an ER because their doctor's office was closed than those living within an MSA.

FIG. 1A illustrates the emergency room visits per 1000 population in the U.S. as of 2010. (Henry J. Kaiser Family Foundation, “Hospital Emergency Room Visits per 1,000 Population, 2010”, http://www.statehealthfacts.org/comparemaptable.jsp?yr=138&typ=1&ind=388&cat=8&sub=217&sortc=1&o=a&print=1, Sources: 1999, 2000, 2001, 2002, 2003, 2004, 2005, 2006, 2007, 2008, 2009, and 2010 AHA Annual Survey, Copyright 2012 by Health Forum LLC, an affiliate of the American Hospital Association, special data request, April 2012, available at http://www.ahaonlinestore.com). FIG. 1B illustrates the total number of hospitals in the U.S. in 2010. (Henry J. Kaiser Family Foundation, “Total Hospitals, 2010”, http://www.statehealthfacts.org/comparemaptable.jsp?ind=382&cat=8&print=1).

The CDC Report (Gindi et al.) provides preliminary estimates of reasons for emergency room use among U.S. adults aged 18-64 whose last visit in the past 12 months did not result in a hospital admission, by health insurance status, area of residence (within or outside an MSA), and other selected variables. FIG. 2A presents the percentage who had selected reasons for last emergency room visit, among adults aged 18-64 whose last visit in the past 12 months did not result in hospital admission: United States, January-June 2011. From January through June 2011, among adults aged 18-64 whose last hospital visit in the past 12 months did not result in hospital admission: An estimated 79.7% of adults visited the emergency room for reasons reflecting lack of access to other providers, significantly more than the 66.0% of adults who visited because of seriousness of the medical problem (FIG. 2A); and the most common individual reasons for the last emergency room visit were: only a hospital could help (54.5%), the doctor's office was not open (48.0%), or there was no other place to go (46.3%). Estimates for 2011 are based on data collected from January through June. Data are based on household interviews of a sample of the civilian noninstitutionalized population. “Seriousness of medical problem” and “Lack of access to other providers” are summaries based on positive responses to any of the related detailed reasons below each of the two main categories. Respondents could select more than one reason. SOURCE: CDC/NCHS, National Health Interview Survey. Sample Adult Supplemental component.

FIG. 2B presents the percentage who had selected reasons for last emergency room visit, among adults aged 18-64 whose last visit in the past 12 months did not result in hospital admission, by insurance coverage status at time of interview: United States, January-June 2011. (Gindi et al.). With respect to the values 61.6 and 30.9 reflected in FIG. 2B, it is noted that these values significantly differ from private insurance, p<0.05. With respect to the values 61.6, 38.9, 30.9 and 49.9 reflected in FIG. 2B, it is noted that these values significantly differ from public coverage, p<0.05. Estimates for 2011 are based on data collected from January through June. Data are based on household interviews of a sample of the civilian noninstitutionalized population. SOURCE: CDC/NCHS, National Health Interview Survey, Family Core and Sample Adult Supplemental components.

TABLE 1
Summary of Emergency Department Visits in U.S. Source: CDC.
http://www.cdc.gov/nchs/fastats/ervisits.htm. Tables 1, 4, 14, 24:
CDC, “National Hospital Ambulatory Medical Care Survey: 2009
Emergency Department Summary Tables, http://www.cdc.gov/
nchs/data/ahcd/nhamcs_emergency/2009_ed_web_tables.pdf.

| | ER Facilities | | |
|---|---|---|---|
| | | 2009 | |
| Quick | Visits | 136.1 | million |
| Facts | Injury-related visits | 45.4 | million |
| | Visits per 100 persons | 45.1 | |
| | Patients seen less than 15 minutes | 21.7% | |
| | Visits resulting in hospital admission | 12.6% | |
| | Visits resulting in transfer | 2% | |
| | to a different hospital | | |

From 1996 to 2006, the annual number of emergency department (ED) visits increased approximately 32% from 90.3 million to 119.2 million, according to the Centers for Disease Control and Prevention. Simultaneously, as the number of patient visits increased, the number of hospital EDs decreased from 4,019 to 3,833, increasing the number of annual visits per ED and contributing to the phenomenon of overcrowding.

Additionally, the role of the ED has evolved from providing primarily life-saving treatment to providing urgent, unscheduled care. The ED has also become more accommodating to patients unable to gain access to their primary care providers, as well as to those who are Medicaid beneficiaries and patients without insurance.

According to the American Hospital Association, 60 percent of hospitals in the United States lose money providing patient care. The majority of this loss involves patients who gain access to the hospital through the Emergency Department. While that percentage might seem high, it is even more shocking when paired with the statistic that healthcare providers lose $60 billion a year due to registration errors alone.

ER wait times have been an issue for a long time and for many healthcare institutions. The national average for seeing a doctor from the time one walks into an emergency room to seeing a doctor is roughly 2 hours. This is somewhat frustrating because it is the doctor that ultimately makes the clinical decision as to whether or not a patient can simply receive a prescription for what may be a benign problem versus remaining in the ER for a complete and thorough workup. Waiting for 2 hours to see a doctor for a problem that may only require a 5-minute visit does not make sense to anybody.

There are many reasons for such long wait times to see a doctor in the ER (often called the door to doc time) and also why after seeing a doctor, the wait to be discharged home can be long (this is often called the throughput time). Suffice it to say that some ERs have figured out how to decrease the many rate limiting steps, and are able to get patients seen by a doctor in less than 15 minutes on average while discharging the patients that need to be discharged in less than an hour. These ERs are based in highly competitive and lucrative markets with patient demographics that have high percentages of insured populations. The surrounding hospitals and ERs are in fierce competition to acquire whatever edge they can muster to attract these highly sought after ER patients by focusing on and implementing the following: 1. Excellent quality of care clinically; 2. High-end physical plant; 3. Concierge type atmosphere; and 4. Minimizing the time to see a physician and the time to discharge from the emergency room.

These emergency rooms spend significant amount of marketing and brand management dollars to attract these highly sought after ER patients and keep them once they are in the system.

Rise of Freestanding Hospital Emergency Rooms.

The decline in traditional ER/ED availability plus the increase in demand for health care is leading to the emergence of new and innovative health care options. One of these options is freestanding emergency centers which are walk-in medical facilities that provide emergency care to the general public and are located separate and distinct from a hospital. They are present in about 16 states and operated by physicians, hospitals or non-medical entrepreneurs. (See, Ayers, A., “Emerging Business Models Freestanding Emergency Rooms”, http://www.ucaoa.org/docs/Article_Freestanding.pdf). Freestanding emergency centers have some distinct differences over the traditional hospital ER/ED. According to Ayers, these include:
Better economics (they can break even with only 15-40 patients per day)
Limited or no ambulance service
Lower hospital admission rates (3%-5% versus 16% in hospital ER/EDs)
Reduced length of stay (60-90 minutes versus 3+ hours at hospital ER/EDs)
Lower acuity patients

TABLE 2
Demographic Comparison of Houston-area Freestanding
Emergency Rooms to the Community as a Whole. (Ayers).

| | | 24-Hour | Houston, Texas |
|---|---|---|---|
| | | ER Center | Combined Statistical |
| | | 1 Mile Radius | Area |
| Residential Density | Population per Sq. Mile | 4,740 | 1,395 |
| | Households per Sq. Mile | 1,771 | 484 |
| Household | % Married Household w/ | 29% | 31% |
| Structure | Children Present | | |
| | % Single Female Household | 5% | 18% |
| | w/Children Present | | |
| Ethnicity/Race | % Hispanic | 22% | 35% |
| | % African American | 7% | 17% |
| Household Income | Median Household Income | $88.686 | $54,146 |
| | % Households w/Income | 16% | 23% |
| | Less than $30k | | |
| | % Households w/Income | 46% | 24% |
| | Greater than $100k | | |
| Employment | Employment per Sq. Mile | 3,212 | 653 |
| Density | Businesses per Sq. Mile | 186 | 31 |

Most importantly, freestanding emergency centers are most likely to be located in affluent, suburban retail areas. One of the largest concentrations of freestanding emergency centers is found in Houston, Tex. There are more than 35 of these centers in the area and they are found in high-traffic, high-visibility retail strip centers serving well-established, high-income, high density residential areas. In general they are more “up market” in their branding and facility décor with luxury furnishings, granite countertops, free wireless Internet access, exam room cable television, gourmet coffee and refreshment bars, children's play areas and pediatric-themed rooms providing an experience that is more akin to a “day spa” than a cold, sterile hospital ED.

Free standing emergency rooms may choose to opt out of government operated insurance plans such as Medicare, Medicaid or Tri-Care and hence are not technically subject to the Emergency Medical Treatment and Active Labor Act (EMTALA) since EMTALA only applies to CMS (Center for Medicare and Medicaid Services) participating healthcare facilities. However, all freestanding emergency rooms are obligated to provide emergency care services to all those who have true emergencies regardless of their ability to pay.

Factors Driving Freestanding Emergency Room Growth.

There are several factors driving the growth of freestanding emergency rooms. According to Ayers, these include:
Increased demand of ER services
Long wait times due to dysfunctional legacy ER/EDs
Ability for a hospital to extend their physical geography and brand without the high cost of constructing a new hospital
Differentiation from competing hospitals
Identical reimbursement when compared to hospital ER/ED

Concerns Over Freestanding Emergency Rooms.

While many communities are adopting the new model of freestanding emergency rooms, many people are concerned about the long term effects on our healthcare system. Many see these private clinics only treating people with insurance or those who have the ability to pay directly. The rest are being left for traditional public emergency rooms, which are obligated by law to care for patients regardless of their ability to pay. Another concern is the ability of the private clinics to make healthcare information available to a patient's primary care physician. Perhaps more concerning though is the fact that the indigent and uninsured are being forced to go to legacy ERs while at the same time the profitable patients (i.e. ones that have insurance to pay for services) are leaving these same facilities. This means that the legacy ERs will face an increasingly more difficult task of remaining financially solvent. (See, Barnett, E. C., “The Problem with Private Emergency Rooms”, http://www.seattlemet.com/news-and-profiles/publicola/articles/the-problem-with-private-emergency-rooms, Dec. 27, 2011).

ER Trends.

The market can be divided into two categories: 1) automated electronic registration products and services, and 2) hospitals implementing streamlined or “lean” ER processes. As the load on ERs increases across the country, hospitals are working to streamline their processes. Many are attempting to implement “lean” processes which arose from Japanese automakers after World War II and were implemented into manufacturing around the globe.

There are a few new technologies in the market currently that attempt to address the many times inefficient and cumbersome process of emergency room and hospital registration in general. One involves the use of a self-serving kiosk. These self-service kiosks are being used with growing frequency in hospital ambulatory settings and emergency departments. These are basically interactive computer stations that come in a variety of designs and are able to perform self-service tasks such as patient check-in and collection of co-payments. In a hospital waiting area, they have the ability to speed the process for patients and take some of the workload from registration personnel who can then be freed up to help patients with more complicated and critical registration or payment issues. The problem with kiosk systems includes its cost-effectiveness and issues with system integration.

Another new technology available to address emergency department and hospital registration involves scanning a patient's PDF417 bar code that is present on the driver's license. This technology has been developed by Honeywell. Registration personnel are able to capture the scanned information quickly. This information then gets transmitted to the Meditech application in use by the hospital. The information transmitted is auto-populated within the Meditech software. The problem with this technology is that the information transmitted is fairly limited as far as what gets captured. Also the technology may not be compatible with other systems in use by other hospitals.

There are a few academic institutions and trade organizations that have considered and even implemented the idea of using smart card technologies to help make patient record-keeping and communications of health information across health systems easier and more efficient. But these smart card technologies are often expensive. These smart cards also have the problem with limited and finite capacities. These ideas and applications have not obtained much traction since there have not been solutions that incorporate all the benefits to all stakeholders involved including cost efficiency, convenience and easy to use technology.

Another idea gaining ground is being borrowed from the restaurant industry. The third largest hospital corporation, Tenet Healthcare Corp. (THC), is providing online reservations at some of its ER facilities. The service is designed to boost patient satisfaction and improve efficiency which should help increase the overall profitability of the hospital. (Armour, S., “ER Concierge Services at Hospitals Boost Bottom Lines”, Bloomberg News, Nov. 26, 2012, http://www.bloomberg.com/news/2012-11-21/er-concierge-services-at-hospitals-boost-bottom-lines.html).

This type of concierge service is provided by a Nashville, Tenn. company called InQuicker, LLC (InQuicker.com). InQuicker is an online web site that allows patients to check-in and wait online to reduce their wait time in an Emergency Room or Urgent Care Center and book Doctor's appointments instantly. Patients wait at home until the designated appointment time. More than 140 hospital facilities utilize the InQuicker.com online ER reservation system and InQuicker.com claims to have saved patients over 2,897,000 wait time minutes. According to InQuicker.com, InQuicker patients spend 70% less time in the waiting room than traditional ER visitors. Patients must describe their ailments when making a reservation and the online booking system won't accept requests that involve serious symptoms. Instead, people with serious issues such as chest pains are directed to immediately go to the hospital or to call 911.

These third party companies and healthcare organizations have employed an internet based electronic registration platform that effectively transfers the wait time typically spent in the ER waiting rooms to waiting at home or other locations of patient choice. However, many healthcare experts are not so positive about these online reservation systems for several reasons. First, many poorer people don't have access to computers or smartphones to make the reservations. Second, many experts think that if you are making an appointment it is not an emergency. The problem with this approach is that registration is still required and information must be input when patients are often in distress, in pain, bleeding etc.—all the reasons why one would go to an emergency room in the first place. Furthermore, this at-home internet registration process circumvents a very important and crucial aspect of an emergency room visit: the triage process performed by trained medical professionals. The “register online” methodologies assume that the untrained public can correctly self-triage what is an emergency that immediately needs medical attention versus emergencies and urgencies that can wait a little longer—this is a potentially dangerous proposition. Many mild “ulcer” pains have in reality been the result of acute heart attacks, and an untrained layperson ought not to be placed in a situation where they are self-triaging and potentially making a mistake that could truly be life-threatening.

Other prior art systems have attempted to address these problems. For example, ERMedStat (Maryville, Tenn.) (ermedstat.com) employs the use of smart phone technology and QR (quick response) codes to permit first responders with access to the patient's stored medical data. A QR (Quick Response) code is a matrix or two-dimensional bar code. The code consists of black modules against a white background and is popular due it's readability by Smartphones and storage capacity. ERMedStat advertises that it has a patent pending for use to store an individuals' critical care medical information. ERMedStat members have the ability to carry their critical medical information with them, wherever they are, wherever they need it. In the event of a medical emergency, any First Responder (Police Officer, Firefighter, EMT), ER nurse, or doctor can scan the QR code with a Smartphone and display the critical care information the patient has provided in his or her secure online profile. As a backup, the first responder may visit the ERMedStat mobile site from any Smartphone and enter the Patient ID# located on the back of either card. In the absence of a Smartphone, the First Responder can call a toll-free number (also printed on both cards) to be connected with a live operator, who can provide critical care information verbally.

The ERMedStat system only collects life-saving medical information and does not require social security or driver license numbers, eliminating the threat of identity theft. However, anyone can access the patient's medical profile if the card is lost or stolen, much the same way as a first responder would have access to the information. If a card is lost or stolen, ERMedStat provides a mechanism to simply order a replacement card set online, which will nullify the original purchased cards. The ERMedStat is HIPAA compliant because the member profile contains only relevant life-saving information as listed by the client. The client grants ERMedStat permission to release this information to the necessary parties through the Terms of Service agreed to at Checkout. Upon purchasing an ERMedStat membership, each member receives a reflective shield to be placed on the rear bumper or rear windshield. This is to make it easier for First Responders to identify the vehicle driver as an ERMedStat member. The member will also receive a wallet card and one keytag for their key chain. Both cards contain a unique QR (Quick Response) code, which when scanned by a Smartphone, links to the member's critical care information. The member information may be updated as often as needed at no expense by visiting www.ERMedStat.com. ERMedStat members receive exclusive discounts in their local area by simply presenting their active membership card.

Similarly, MyInfo911.com (Palm Coast, Fla.) provides a picture ID card, stickers and key chain tags that also contain a QR code. It provides first responders instant access to the person's medical history, medications, blood type, allergies, etc. A three digit personal PIN number is used to secure access to the web data, but this PIN number is printed on the card itself along with the patient's critical care data, such as blood type, diabetic, allergies, religion, plus emergency contact information.

Also, Lifesquare, Inc. (Menlo Park, Calif.) (lifesquare.com) also provides a QR code-based, webhosted, emergency first responder medical information system that securely relays essential health information to paramedics in an emergency. The user enters only the information that a paramedic would find useful in an emergency. The Lifesquare system does not store the member's entire medical record—just the member's essential health profile, like allergies, medications, basic personal information, and emergency contacts. The information is stored securely on redundant, fully HIPAA-compliant servers. Only authorized Marin County paramedics can access the stored Lifesquare information, but only in an emergency and only for a short period of time. The Lifesquare system employs stickers that contain a QR code, but do not contain any other information.

ScanMedQr.com (Oklahoma City, Okla.) manufactures silicon bracelets that have quick response codes on them. An emergency rescue or health professional could use their smartphones and scan the QR code and they will be shown the patient's own medical homepage. ScanMed QR provides their members the ability to carry and edit their own Emergency Health Record. Within seconds, the member's profile displays medical conditions, physician name and number, allergies, medications with dosages, contact names and numbers and unlimited additional vital information. Profiles will not stay the same and when they change, like a medication and/or dosage, the user simply logs into his or her profile, revises and then saves the revised information. Only the information that the user makes available will be shown upon scan. Each line of information for the user's profile will give the user the ability to “show” or “hide” that information when the ID band is scanned. ScanMEdQr recommends that the user only provide information that the user would want an emergency responder or Good Samaritan to have in the event of an emergency. According to ScanMedQr, because their customers choose to opt-in to have their information displayed to emergency responders and medical staff, ScanMed QR does not fall under the HIPAA rules. The ScanMEdQr QR images can be scanned and read by any QR scanner or 2-D barcode scanner.

The S.M.A.R.T. Association, Inc. (“SMART”) describes a Smart card system for use in the healthcare industry. (SMART, “SMART Cards and Healthcare: The Time Has Come”, http://www.smartassociation.com/solution/smartcard.cfm, 2009). According to the SMART, the LifeMed Card program takes the best from the web and marries it with the portability and security of off-line systems. The program has several components that all work together to save time for the patient, reduce costly errors for the hospital or physician, and enhance the overall experience. Patient data includes basic demographic data, insurance information, emergency information, allergies, medical conditions, and recent prescriptions. Information is uploaded by patients through the hospital's web site and securely encrypted onto a Smart card. When patients come to the hospital, they present the Smart card. The Smart card information, which can be updated, is then accessed by a hospital's admissions unit and matched to the hospital's data management software. Kiosks at the hospital also allow a patient to pre-register using data stored on the Smart card to populate standardized patient forms. Additionally, ambulances and EMTs will have portable readers that can view the patient's Smart card data in emergency situations, providing richer and more accurate information.

Additionally, SMART also presents a white paper describing the use of smart cards in the healthcare industry: (Grogan, D., “Smart Cards in Healthcare: A Logical Evolution”, SMART, Apr. 16, 2007, http://www.smartassociation.com/solution/smart-card-white-paper-online.pdf). In this regard, Grogan states that Smart cards, or otherwise commonly called “chip” cards, were developed in 1974 as a method to pay for telephone calls without coins. This first ‘stored-value’ application opened the flood gates to a myriad of uses for this technology. Once considered the vanguard of technology, Smart cards have found their way into mainstream commerce, including healthcare. According to Grogan, at the very least, Smart cards can provide valuable, accurate patient information such as name, date of birth, blood type, allergies, medications, and medical conditions—crucial information for any healthcare provider. At best, Smart cards can usher healthcare into the true digital age. Healthcare can benefit dramatically from the utilization of Smart card technology as a stop-over on the way to a fully digital industry.

Neame, R., “Smart cards—the key to trustworthy health information systems”, BMJ, 1997; 314:573; http://www.bmj.com/content/314/7080/573#alternate, outlines what smart cards are and why they are so important in managing health information. The author notes that smart cards would enable individuals' identities to be authenticated and communications to be secured and would provide the mechanisms for implementing strong security, differential access to data, and definitive audit trails. Patient cards can also with complete security carry personal details, data on current health problems and medications, emergency care data, and pointers to where medical records for the patient can be found. Provider cards can in addition carry authorizations and information on computer set up.

In healthcare, smart cards may be used as Medical Cards, as Health Insurance Card or Medical File Access Card. This has the following advantages: Reduces routine paperwork; Eliminates errors and fraud; Speeds up payment and claim processes; Inexpensive equipment setup; Patient controls doctors' access to information; Patient's medical history and data can be stored and becomes readily available using a card reader; Pharmacist has access to prescription information only; and Allows automatic check for medication incompatibility. (See “Smart Cards”, http://ewh.ieee.org/r10/bombay/news5/SmartCards.htm).

According to Xiao, C. and Yu, A., “Medical Smart Card System for Patient Record Management”, http://step.berkeley.edu/White_Paper/Xiao_Yu.pdf, University of California, Berkeley, rising healthcare spending has led to an increase in calls for ways to reduce the cost of healthcare. Amid the debate on the best approach to cut costs in the healthcare system, one of the few bipartisan provisions is the need to integrate modern technology into the storage and transfer of medical records. Current attempts to establish such electronic medical records are challenged by concerns about patient privacy, issues with the incorporation of old records, and budget limitations. The authors propose the development of personal portable healthcare record smart cards and a corresponding framework to simplify maintenance and transfer of patient records as an incremental step towards a nationalized electronic records system. The authors characterize their proposal as a feasible and cost-effective system that applies existing technology to address inefficiencies of the current paper based medical records system; simultaneously, it also serves as a transition system to facilitate the adoption of completely electronic medical records.

Also, Hansen, M., “Smart Card Technology and Healthcare Information: A Dynamic Duo”, University of San Francisco, http://repository.usfca.edu/cgi/viewcontent.cgi?article=1009&context=nursing_fac, Jan. 1, 2008, describes a healthcare smart card (HSC), how it can be used, and why it is beneficial and concludes that HSCs are being used by millions of people around the globe. The United States needs to conduct more research on the use of smart card technology for storing citizen's ID and protected data, obtaining medical and payment information, and using biometric authentication. Hansen notes that perhaps one day US citizens will be able to access their healthcare records from the convenience of their home personal computer or the connection provided in the physician's office and questions whether we are ready for the marriage of smart card technology and health care information as a standard dynamic duo? Hansen also notes that anxiety about healthcare while away from home or in a foreign country can be reduced through HSCs and suggests that there be an HSC in each US citizen's pocket because quick access to pertinent patient information saves lives.

The Personal Health Record (PHR) supplier market has three primary types of current offerings: (1) Health plan web sites; (2) Physician and hospital sites; and (3) Private company offerings. In general, both health plan sites as well as physician/hospital sites tend to offer PHR's as a portion of their overall EMR (electronic medical records) solutions. While this can potentially be beneficial in that all medical records are housed in one location, these systems often tend to be clumsier and more complicated. For example, many early PHR systems required consumers to enter their records manually or scan paper records. Hence, they often have a low adoption rate among consumers. Furthermore, if a consumer changes plans or moves the information is not easily moved with them. Private company PHR offerings, on the other hand, provide the benefits of simplicity (a key factor in adoption) as well as the neutrality of an independent organization. For many consumers, especially seniors, this has strong appeal. Today, however, the typical PHR user is a senior or other person with chronic health conditions, but the use of a PHR system can be beneficial to any consumer.

There is no product to date that employs QR based technology with the added benefit of limitless cloud based storage/capacity to help streamline and improve the registration processes in emergency rooms. Furthermore, there has not been any dialogue to address the specific registration process in emergency rooms that require EMTALA compliant methodologies. As such, there remains a need for a medical patient ER registration methodology designed to streamline the patient registration process in ERs. There also exists a need to directly address the issue of emergency department registration and triage inefficiencies. There also remains a need for a medical patient ER registration method that will improve the quality and efficiency of access to vital healthcare information for every patient, ancillary care entities and healthcare institutions through new technology and innovation.

### BRIEF SUMMARY OF INVENTION

The present invention addresses these needs by streamlining the patient registration process in Emergency Rooms through effective utilization of QR code technology. The use of this readily available, proven technology will make the patient registration process much less time consuming and much more efficient. The system is compliant with the requirements of the Emergency Medical Treatment and Active Labor Act (EMTALA) and the Health Insurance Portability and Accountability Act (HIPAA).

One embodiment of the present application describes a method of streamlining intake registration of a patient at a healthcare provider facility comprising the steps of: (a) providing a secure, member-accessible online information storage database system for online storing of the patient's private health information (PHI) data; (b) providing a data security level to secure the PHI data; (c) providing a secure web-based interface portal for the patient (or a person authorized by the patient) to register the patient to become a member of the online information storage database system; (d) establishing a secure patient member account for each patient; (e) creating, via direct patient interface through the web-based interface portal, a secure, unique patient PHI profile within the online information storage database system wherein only the patient (or those authorized by the patient) may add to, subtract from or otherwise modify, update or edit the PHI profile and other data contained in the PHI profile; (f) creating a unique, secure, readable scanning code that will permit access to the PHI profile; (g) placing the readable scanning code on media that may be carried by the patient; (h) providing a scanner at the health care provider facility for scanning and reading the readable scanning code, the scanner being interfaced with at least one electronic health record (EHR) system, comprising EHR fields, at the healthcare provider facility; (i) scanning the readable scanning code on the scanner; (j) downloading information from the PHI data required for the intake registration of the patient to obtain scanned registration data; (k) interfacing the scanner at the healthcare provider facility with any other desired EHR systems at the healthcare provider facility; and (l) automatically populating the healthcare provider facility's EHR systems with the scanned registration data.

The method has application at any healthcare provider facility, such as, emergency rooms, emergency departments, freestanding emergency centers, walk-in medical facilities, hospital intakes, specialty hospitals, hospital systems, medical and dental clinics, health clinics, doctor's offices, dentist's offices, medical labs, emergency response vehicles, and other health care provider locations.

The readable scanning code of the present method is preferably a Quick Response (QR) code and the scanner is a QR reader/scanner. The patient's QR code can be read by a QR scanner, smartphone or mobile phone with a camera and QR code reader software. In other embodiments, the readable scanning code can include a Quick Response (QR) code, a bar code, a matrix bar-code, a two-dimensional code, a radio-frequency identification (RFID) code, a near field communications (NFC) code or the like or combinations thereof.

The online information storage database system housing the patient's PHI is maintained on one or more networked servers. Preferably, the online information storage database system is maintained in a cloud-based storage system. The online information storage database system is accessible through a web-based interface portal using mobile devices with an internet connection such as smart phones, mobile phones, and tablets, as well as non-mobile devices with an internet connection such as desktop computers and personal computers (PCs). As a result, the patient's PHI data and PHI profile are accessible thorough both mobile and non-mobile devices so long as the devices have an internet connection.

The media containing the readable scanning code may include, for example, wallet sized cards, pendants, key chains, bracelets or stickers displaying such readable scanning code. In one embodiment, the media containing the readable scanning code is an electronically displayable graphic image capable of being displayed on a screen of the patient's smart phone device, tablet device, PC, or the like, wherein a suitable mobile website or mobile smart phone, tablet, or PC, is first installed onto the patient's device to permit the patient's device to display the generated QR code and to permit access to the patient's member account to input, read, and edit the PHI data.

In use, the patient can typically be the person scanning his or her own readable scanning code on the scanner. In other embodiments, it is possible to permit a patient's guardian or other authorized representative to scan the patient's readable scanning code on the scanner. In other embodiments, medical personnel may scan the patient's readable scanning code on the scanner.

The method may employ multiple levels (or options) of PHI data security levels available to the patient. In one embodiment, two sequential PHI data security levels are provided for the patient to choose from, the first security level being the default and permitting the PHI data to be obtained by scanning the readable scanning code, the second security level requiring the steps of having the patient first create a special pin code as part of the step of creating the PHI profile, and then inputting the pin code after scanning the readable scanning code at the healthcare provider facility to enable the healthcare provider facility access to the patient's additional PHI data.

In another embodiment, the initial downloading of the patient's PHI data upon scanning the patient's readable scanning code at the healthcare provider facility is limited in content to EHR fields required for registration at the facility, and does not contain any information about payor or insurance coverage. Limiting the content to, e.g., initially prevent disclosure of the patient's health insurance information, provides for compliance with EMTALA. EMTALA is a statute which governs when and how a patient must be (1) examined and offered treatment or (2) transferred from one hospital to another when he is in an unstable medical condition. Generally speaking, EMTALA requires most hospitals to provide an examination and needed stabilizing treatment, without consideration of insurance coverage or ability to pay, when a patient presents to an emergency room for attention to an emergency medical condition (www.emtala.com). As such, the present invention addresses these compliance issues by shielding access to the patient's ability to pay or consideration of insurance coverage until such examination and needed stabilizing treatment has been rendered.

The method of the present disclosure also includes wherein the data security level set by the patient will always permit the healthcare provider facility to access the minimum PHI data required for patient intake registration and a patient medical screening exam, but will permit the patient to protect additional patient protected PHI data requiring further patient authorization to obtain such additional patient protected PHI data.

The system is preferably designed to be compliant with the requirements of EMTALA and HIPAA.

Interfacing the scanner at the healthcare provider facility with any other desired EHR systems at the facility may be accomplished via standardized data interface convention, and the like. In one embodiment, the standardized interface convention is the Health Level 7 (HL-7) convention.

In the methods of the present disclosure, the healthcare provider facility may also first create a healthcare provider facility profile within the web-based interface portal online information storage database system and then invite its patients to complete a database enrollment form through its facility profile via the web-based interface portal so that when the patient next visits the healthcare provider facility, the patient's PHI data will be readily scannable on the healthcare provider facility's scanner and automatically populated into the facility's HER system. The invitation to patients to complete the enrollment could take place on site or remotely.

In one aspect of the present method, the online information database storage system and web-based interface portal may be provided and operated by a third party by subscription. In one embodiment, the healthcare provider facility can obtain the subscription to the online information database storage system and in turn provide its patients with access to the system. In another embodiment, the patient obtains the subscription to the online information storage database system.

In another embodiment, the patient's readable scanning code is universally readable, via scanner, into any EHR system at any healthcare provider facility. The method can include the further step of providing the healthcare delivery facility personnel with access to the patient's PHI data from the EHR system.

The web-based interface portal security may utilize any web available security (it being appreciated that web security is an ever evolving area). In one embodiment, the web-based interface portal security comprises HTTPS protocols, hypertext transfer protocol secure, secure socket layers, transport layer security, TPL, PHP secure sessions, data encryption algorithms, personal pin codes, and patient-created password that is protected by an MD5 encrypted password hashing algorithm. As an added security measure, where, for example the patient opts out of the system or loses his or her mobile device containing the readable scanning code, the method provides the additional step of providing a mechanism for remotely deactivating the readable scanning code.

As noted, the present method may include the option of providing the patient with the ability to set the data security level of the readable scannable code to permit emergency workers to gain access to the PHI data upon scanning the readable scannable code or upon calling a call-in center.

The present method may also advantageously provide for a web-based or a telephone call-in center capable of providing pin codes or any additional instructions on usage of the electronic registration card, including any of the added 911 functions.

In one embodiment, the patient preselects a desired pharmacy to fill prescriptions and the prescriptions are automatically and electronically transmitted to the desired pharmacy.

In another embodiment, a survey is automatically generated, the survey is sent to the patient, and an email reminder is sent to the patient to request the patient to complete the survey.

In another embodiment of the method for streamlining intake registration of a patient with a healthcare provider facility, the method comprises the steps of: (a) providing a secure, member-accessible online information storage database system for online storing of the patient's private health information (PHI) data; (b) providing a data security level to secure the PHI data; (c) providing a secure web-based interface portal for a patient to register to become a member of the online information storage database system; (d) establishing a secure patient member account for each patient; (e) creating, via direct patient interface through the web-based interface portal, a secure, unique patient PHI profile stored within the online information storage database system wherein only the patient may add to, subtract from or otherwise modify, update or edit the PHI profile, and other PHI data contained in the PHI profile; (f) uploading the PHI data required for the intake registration of the patient to the healthcare provider facility via the web-based interface portal, wherein the healthcare provider facility is capable of receiving the PHI data; and (g) automatically populating the healthcare provider facility's electronic health record (EHR) systems with the PHI data.

In another embodiment, the online information storage database system is compliant with requirements of the Emergency Medical Treatment and Active Labor Act (EMTALA) and the Health Insurance Portability and Accountability Act (HIPAA).

In another embodiment, the web-based interface portal further comprises an alert ER function to allow the patient to alert a participating ER that the patient is in route to the participating ER.

In another embodiment, the alert ER function has the further capability of allowing the patient to upload information comprising the patient's current chief complaint, gender, age, and estimated time of arrival to the participating ER.

In yet another embodiment, the alert ER function has the further capability of assessing whether the patient's current chief complaint is a life-threatening emergency, and if so, the alert ER function directs the patient to immediately dial 911 emergency medical services.

In another embodiment of the present method, the method provides a patient's PHI data to a healthcare provider facility comprising the steps of: (a) providing a secure, member-accessible online information storage database system for online storing of the PHI data; (b) providing a data security level to secure the PHI data; (c) providing a secure web-based interface portal for a patient to register to become a member of the online information storage database system; (d) establishing a secure patient member account for each patient; (e) creating, via direct patient interface through the web-based interface portal, a secure, unique patient PHI profile stored within the online information storage database system wherein only the patient may add to, subtract from or otherwise modify, update or edit the PHI profile, and other PHI data contained in the PHI profile; (f) providing a mobile device to display the PHI data in a human-readable format so that the PHI data can be reviewed by a healthcare provider facility staff.

In another embodiment, the PHI data in a human-readable format is used to register the patient with the healthcare provider facility.

### BRIEF SUMMARY OF DRAWINGS

FIG. 1A illustrates the ER visits per 1000 population in the U.S. as of 2010.

FIG. 1B illustrates the total number of hospitals in the U.S. in 2010.

FIG. 2A presents the percentage who had selected reasons for last emergency room visit, among adults aged 18-64 whose last visit in the past 12 months did not result in hospital admission: United States, January-June 2011.

FIG. 2B presents the percentage who had selected reasons for last emergency room visit, among adults aged 18-64 whose last visit in past 12 months did not result in hospital admission, by insurance coverage status at time of interview: United States, January-June 2011.

FIG. 3 presents an exemplary process flow diagram for the ER/ED patient E-Registration process of the present invention.

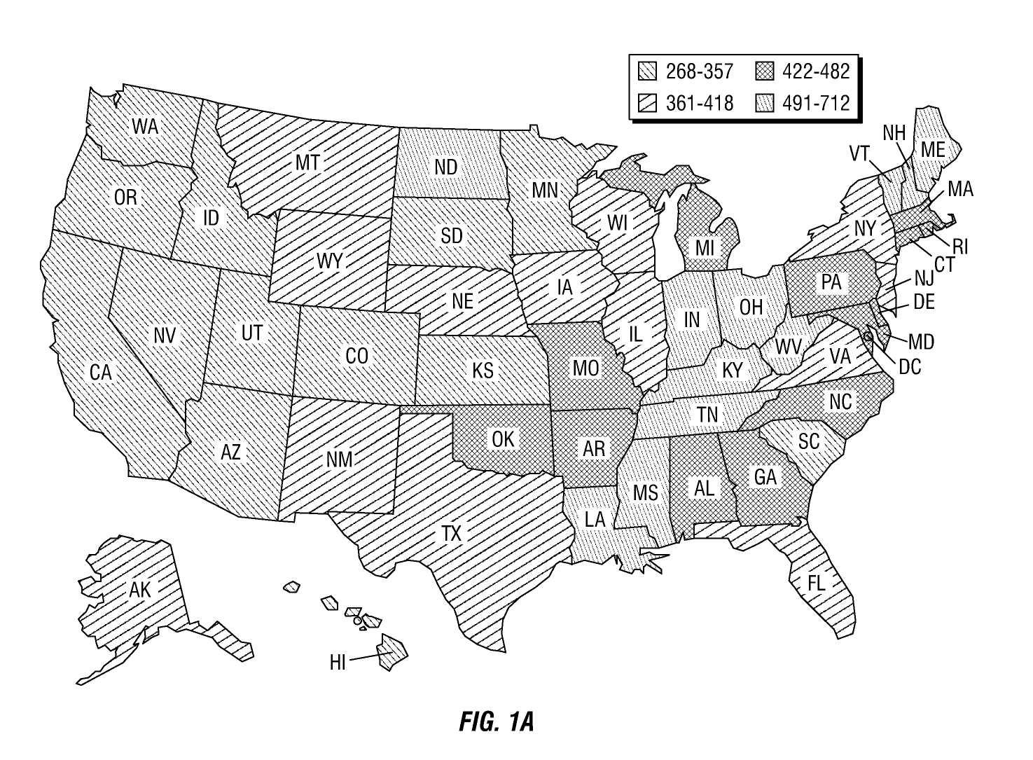

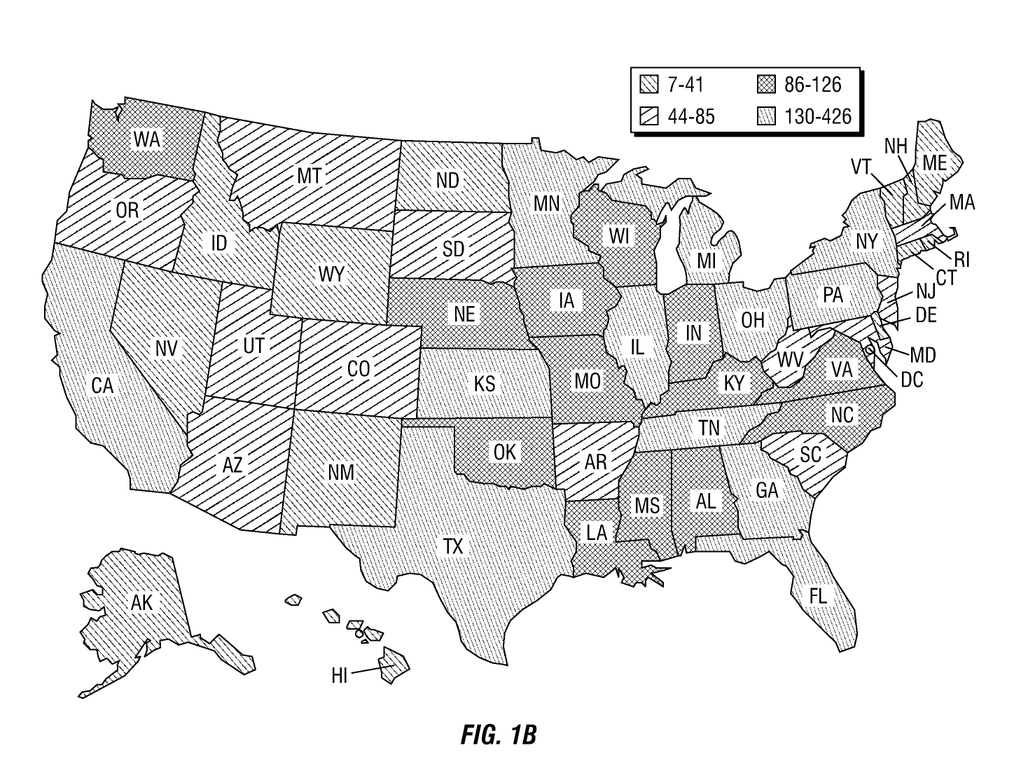

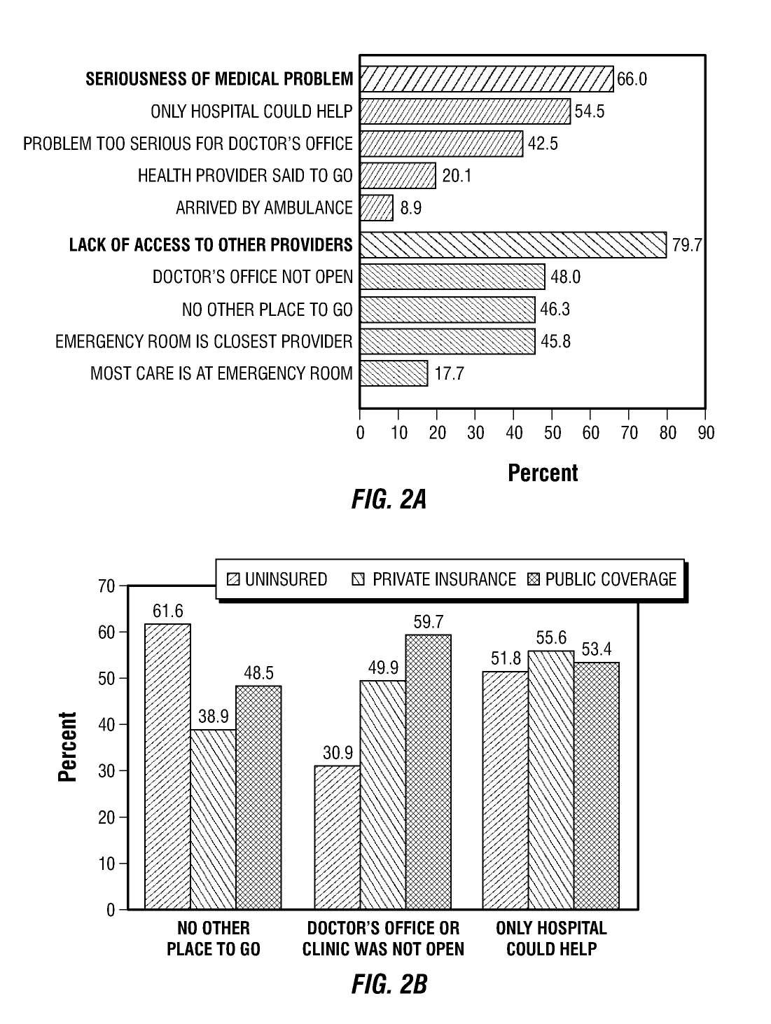

### DETAILED DESCRIPTION OF THE INVENTION

A Personal Health Record (PHR) is a tool that a consumer can use to collect, track and share their past and current health information. They differ from medical records in that PHR data is entered by the consumer themselves and not by medical professionals. In recent years, the popularity of PHRs has risen as organizations of all types including the National Health Council have promoted the benefits and rationale of a Personal Health Record since they can be used by emergency medical personnel and physicians to access important patient data in critical situations.

Personal Health Record includes, but is not limited to, information, data, or records pertaining to a patient's health history (e.g. triage information), medical visits history, and study results. Medical visits history data includes without limitation, information regarding a patient's emergency room visits, clinic/office visits, and hospital admissions. Emergency room visits data includes information such as the date of visits to the emergency room and discharge instructions of the patient. Clinic/office visits data includes without limitation, information such as the date of visits to the clinic/office and a summary of the visit of the patient. Hospital admissions data includes without limitation information such as admissions dates to a hospital and admission summary of the patient. Study results data includes without limitation, imaging studies (e.g. ultrasound, magnetic resonance imaging, x-ray, computed tomography scans, and special tests, such as echocardiogram, nuclear medicine), electrocardiograms (ECG or EKG), laboratory results, and vital signs. In addition PHR could also include information pertaining to a patient's past and current medications. All of the above information, data, and records are a part of a patient's PHR.

A report from IDC Health Insights suggests that consumers have been slow to adopt personal health records. The primary reason appears to be that consumers have not been familiar with the concept of a PHR. However, as healthcare providers, benefit plans and community organizations begin to educate the public on the benefits of PHRs it is expected that consumer adoption will rise dramatically in the next several years. Furthermore, technology improvements (dedicated PHR web sites, use of QR codes, etc.) will make it easier for consumers to take the plunge into creating their own PHR.

The Personal Health Record market represents a continually growing population of people who are concerned about their healthcare, or the healthcare of a family member. Upcoming structural changes in healthcare, including new collaborative care models, will help drive the adoption of PHRs as will the increasing use of technology that helps consumers overcome their fears about tracking and monitoring their personal health online.

Emergency rooms (ER) require a particular process of patient registration in that it must be EMTALA compliant. ER registration is most often a cumbersome two-step process where: Step 1 includes gathering general patient information that excludes information regarding insurance status (i.e. name, address, SS#, phone# etc.). Step 2 includes when the patient is taken to the clinical area, after the patient is seen and evaluated/screened by clinical personnel, registration paperwork can be completed—this includes providing insurance status. Both steps in the registration process are cumbersome at best, and at its worst, inefficient and distracting to the clinical treatment process. Overall, the full registration process takes between 15-40 minutes depending on how organized and motivated the patients are. Of note: these patients are often in pain, bleeding, limping, wheezing, coughing, and some are even a stroke or heart attack in progress.

The method of the present invention preferably uses QR code technology to allow a streamlined, instantaneous electronic patient registration at healthcare facilities that have traditionally utilized antiquated pen and paper methodologies—a green concept. The method can do more than streamline the registration process. While being triaged in the ER, the QR code can be used to further facilitate the triage process by instantaneously displaying for the clinical staff PMH, Current Medications, Allergies, Past Surgeries etc. It allows clinicians to spend more time treating the patient as opposed to retrieving information.

The present methodology can be implemented at any healthcare provider facility. From a marketing viewpoint, the present methodology also provides an incentive for commercially insured patients to come back to the same facility every time they have an emergency. This methodology permits the facility to generate brand loyalty. The patients are able to avoid the hassles and frustrations of filling out registration paperwork when they are already sick and distressed.

QR readers will be provided to the ERs, and their patients will activate memberships to access the QR registration service. The patients will desire this system to avoid having to fill out paperwork—this methodology streamlines registration. ERs in turn derive tremendous value from utilization of this system: it serves as a marketing tool, it creates brand loyalty, it streamlines registration as a front office function, it streamlines triage, and it saves time from front office to triage.

One embodiment of the present application describes a method of streamlining the intake registration of a patient at a healthcare delivery facility, such as at emergency rooms, freestanding emergency centers, walk-in medical facilities, hospital intakes, specialty hospitals, hospital systems, medical and dental clinics, health clinics, doctor's offices, dentist's offices, medical labs, emergency response vehicles, and other health care provider locations.

To accomplish this methodology, a secure, member-accessible online information storage database system is created and provided for online storing of patient private health information (PHI) data. This database can be hosted in any number of ways known in the art and contemplated in the future, including, multiple networked servers, a cloud-based storage system, with multiple back-up servers, etc. The method provides data security to secure the PHI data. The system will preferably employ a cloud-based solution for critical storage and backup. As a cloud-based solution, the system will be 100% scalable and very economical.

Advantages of cloud based storage include: no concern for capacity, no concern for storage device changes (i.e., it is not a smart card, flash drive, SD card technology that might changes over time), no need for data compression. A further advantage lies in not having storage capacity on the card with the QR code: cost is minimal—nothing is compressed or encrypted onto the QR code itself in contrast to the much higher cost for a smart card based system (where the cost is on the order of $25-$41/card, and the data can be lost if the card is lost). Thus, it is preferred that the patient control the patient's PHI (e.g., on a patient-controlled cloud-based storage system) rather than having this information controlled and held by a healthcare institution.

The patient has complete control of his/her PHI thereby empowering the patient to control his/her PHI. Most databases are controlled and held by healthcare institutions.

A secure web interface/portal is provided for a patient/user to register to become a member of the online database information storage system. Each patient/user then establishes, through the portal, a secure patient user/member account that is unique for each new user. Through this direct patient interface through the portal, a secure, unique patient/user PHI profile is created within the online database wherein only the patient may add to, subtract from or otherwise modify, update or edit the patient's PHI and other data contained in the patient's PHI profile. Patient data includes, for example, basic demographic data, insurance information, emergency information, allergies, medical conditions, past medical history (PMH) and recent prescriptions. The patient's PHI data is stored in this secure online database. Preferably, a third party company operates this website.

The online information storage database system containing the patient's PHI profile and PHI data is accessible through a web-based interface portal using devices with an internet connection such as mobile devices, including smart phones, mobile phones, and tablets, as well as non-mobile, internet-connected devices such as desktop computers and personal computers (PCs). The patient can upload the PHI data required for the intake registration of the patient to a healthcare provider facility via the web-based interface portal, wherein the healthcare provider facility is capable of receiving the PHI data.

The web portal security preferably comprises HTTPS protocols, hypertext transfer protocol secure, secure socket layers, transport layer security, TPL, PHP secure sessions, data encryption algorithms, personal pin codes, and patient-created password that is protected by an MD5 encrypted password hashing algorithm. Other security protocol can be employed as is known, or becomes known, in the art. As another potential security mechanism (or administrative function), the system can be provided with a mechanism for remotely deactivating the scanning code.

The system then creates a unique, secure, readable scanning code that will permit access to the patient's PHI profile stored in the database. The readable code can be selected from the group consisting of a Quick Response (QR) code, a bar code, a matrix bar-code, a two-dimensional code, a radio-frequency identification (RFID) code, a near field communications (NFC) code or the like or combinations thereof. In a preferred embodiment, the readable scanning code is a QR code that can be read by a QR reader/scanner. Scanners can also include smartphones or mobile phones equipped with a camera and QR code reader software.

The readable scanning code, such as a QR code, is placed on media that may be hand carried by the patient, such as, on wallet sized cards, pendants, key chains, bracelets (or other items of jewelry), stickers or other items displaying such readable scanning code. In another embodiment, the media containing the readable scanning code is an electronically displayable graphic image capable of being displayed on the screen of the patient's smart phone device, tablet device, PC, or the like, wherein a suitable mobile website or mobile smart phone, tablet, or PC application, is first installed onto the patient's device to permit the device to display the generated QR code and to permit access to the patient's account to input, read, and edit the patient's PHI data upon scanning the displayed scanning code. This mobile application will also permit the patient to remotely update his or her PHI via such smart phone or other portable device.

One or more scanners are installed at the health care provider location for scanning and reading the patient's hand-carried scanning code, the scanner being interfaced with at least one electronic health record (EHR) system at the facility. In other embodiments, the scanner is interfaced with other desired EHR systems at the health care provider facility. Such interfacing may be accomplished via standardized data interface convention, such as, for example, the Health Level 7 (HL-7) convention. In this regard, in a preferred embodiment, the patient's PHI scanning code is universally readable, via scanner, into any EHR system at any healthcare provider facility. Because of the preferred use of HL7 convention to interface the scanning device to the healthcare facility's EHR system, as well as preferably being a cloud based database, this electronic registration product/process can be used across any EHR platform (i.e. any ER, any health system, any clinic).

When the patient arrives at the heath care provider, the patient's scanning code is scanned on the scanner. In a preferred embodiment, the patient scans the patient's scanning code on the scanner. In another embodiment the patient's guardian scans the patient's scanning code on the scanner. In yet another embodiment, medical personnel scan the patient's scanning code on the scanner. So when patients walk into the ER they can either present a card/sticker/pendant with the QR code on it or present a smart phone (or personal mobile device) displaying the QR code using a mobile app or mobile website.

Upon scanning the patient's scanning code on the scanner, the information is extracted from the patient's PHI data required for the registration process. In a preferred embodiment, the information initially downloaded from the scan of the patient's QR code is limited to be EMTALA compliant, e.g., there is no insurance information provided. The extracted information is automatically populated into the healthcare provider facility's EHR system(s)—initially populating EHR fields required for registration. The system can thereafter provide the healthcare delivery facility personnel with access to the patient's PHI from the EHR.

The system can be designed to provide the patient with multiple PHI data security level options. For example, in one embodiment, the patient has the ability to allow for the sequential security enabled release of PHI. For example, two sequential PHI security levels are provided for the patient to choose from, the first security level being the default and permitting the patient's PHI to be easily obtained by scanning the scanning code, the second security level requiring the steps of having the patient first create a special pin code as part of the step of creating the PHI profile, and then inputting the pin code after scanning the scanning code at the facility to enable the healthcare delivery facility access to the patient's additional PHI.

In another embodiment of the present method, the patient/member is provided with the ability to set the security level of the scannable code to permit emergency workers to gain access to the patient's PHI upon scanning the patient's scannable code or upon calling a call-in center.

The system may be programmed so that the initial downloading of the patient's PHI upon scanning the patient's scanning code at the healthcare delivery facility is limited in content to the EHR fields required for registration at the facility, and does not contain any information about insurance coverage.

In another sequential security enabled release of information mechanism, the patient may also set the security level of the system to always permit the healthcare delivery facility to access the minimum PHI required for patient intake registration and a patient medical screening exam (e.g., EMTALA compliant), but will permit the patient to protect additional patient protected PHI requiring further patient authorization to obtain such additional patient protected PHI. Such further authorization can be achieved via, e.g., a prompt for the patient to enter the patient's security PIN number into the system to permit the healthcare provider facility with full read access to the patient's stored PHI data. So for example, after the patient's initial information is obtained for purposes of registration, after initial history and physical exam is performed by the clinical staff, if the patient is not acutely ill or incapacitated, an input of the patient's PIN code is required by the patient for the patient to release further/complete information regarding, e.g., “Patient Registration Record” and “Patient Protected Health Information Preferences” (which can include information about the patient's medical insurance). If the patient is acutely ill or incapacitated, emergency care would be provided per protocol of the healthcare provider facility and registration is a secondary issue.

The present method may employ a web-based or telephone call-in center capable of providing pin codes or any additional instructions on usage of the readable scannable code or the electronic registration card, including any 911 emergency medical functions. For example, if an EMT scans the patient's QR code, and the patient is unable to provide further access via the patient's pin number (e.g., where the patient is unconscious or otherwise unable to provide the PIN number), provision is made for the EMT to contact an online web or call-in center available 24/7 to provide the PIN number.

As previously described, a web-based interface portal is used to allow a patient to access the patient's PHI profile or PHI data in the online information storage database system, which can be accessed through a variety of internet connected-mobile devices such as smart phones, mobile phones, and tablets, and non-mobile, internet-connected devices such as desktop computers and PCs. In addition, the web-based interface portal allows the patient to upload the PHI data required for the intake registration of the patient to a healthcare provider facility if the healthcare provider facility is capable of receiving the PHI data. The PHI data is then used to automatically populate the healthcare provider facility's EHR system, which comprises EHR fields.

In another embodiment of the present invention, the web-based interface portal also features an alert ER function. The alert ER function allows a patient to alert a participating ER to provide advance notice that the patient is in route or about to be in route to the participating ER. As used herein, a participating ER is an ER that is set up or equipped to receive alerts from an incoming patient currently located at a remote location, to receive a patient's PHI data and/or PHI profile, and/or to receive other critical information concerning the patient, such critical information including but not limited to the patient's current chief complaint, gender, age, and estimated time of arrival to the participating ER, through the web-based interface portal. The alert ER function would allow the patient to transmit, upload, or submit the patient's PHI data and/or PHI profile to the participating ER as well as the critical information to the participating ER through the web-based interface portal.

The alert ER function is beneficial because it allows a patient to register with the participating ER from a remote location, whereby the participating ER will already have the patient's PHI data upon arrival to the participating ER by the patient. As such, the patient would experience less of a delay in receiving emergency care treatment, which would otherwise result if registration with the ER occurred only upon the patient's arrival. With the alert ER function, the patient can register with a participating ER before arrival to the ER which greatly reduces the time spent in the waiting room and allows the patient to receive faster emergency care treatment.

The web-based interface portal allows a patient to access or initiate the alert ER function. In one embodiment, once accessed or initiated, the web-based interface portal displays a list of participating ERs. In another embodiment, the alert ER function lists participating ERs which are in close proximity or nearby to the patient's current location (e.g. within 20 miles of the patient's current location). The location of the patient can be determined by global position satellites (“GPS”) and GPS microchips found in many modern smart phones, mobile phones, tablets, desktop computers, and PCs that are well-known in the art. In another embodiment, the list of participating and nearby ERs is sorted by increasing distance proximate to the patient's current location for added convenience, which is beneficial in an emergency situation. The patient then selects the participating ER that he or she would like to register and be admitted into.

The alert ER function has the capability for assessing whether the patient's chief complaint is a life-threatening emergency that requires immediate assistance with the 911 service. For example, in one embodiment, the alert ER function could display a graphic image of a man or woman's body, and request the patient to select if the patient is male or female. Once the gender is selected, the alert ER function requests that the patient select the area on the body that is causing the patient's current chief complaint. Based on the selection from the patient, the alert ER displays a list of body parts and a list of symptoms that could be ailing the patient. The patient can then select one or more body parts and one or more symptoms. The alert ER function is programmed with medical information to determine if the patient is experiencing a life-threatening emergency or non-life-threatening emergency based on the patient's selections to narrow down the possible causes of the patient's current chief complaint.

With the alert ER function, if the patient is experiencing a life-threatening emergency or otherwise is in need of an ambulance, the web-based interface portal directs the patient to immediately call the 911 emergency medical service (EMS). In another embodiment of the alert ER function, a button to directly call 911 is made available through the web-based interface portal. The call would be made using the patient's mobile phone or the patient's computer with voice over internet protocol (VOIP) technology as well-known in the art. The EMS or ambulance would transport the patient to the nearest ER regardless of whether the ER participates or is otherwise compatible with the alert ER function.

If the patient is not experiencing a life-threatening emergency or is not otherwise in need of an ambulance, then after selecting the participating ER of the patient's choice, the patient enters critical information, including but not limited to, the patient's current chief complaint, age, gender, and estimated time of arrival to the participating ER. The patient then submits this critical information as well as the patient's PHI data and/or PHI profile to the participating ER electronically through the web-based interface portal. Thus, the participating ER receives the patient's PHI data and/or PHI profile and other critical information, thus, allowing the patient to electronically register with the participating ER from a remote location without ever having stepped into the participating ER. This pre-registration would be performed without revealing the payor or insurance status of the patient to comply with EMTALA. In essence, the alert ER function not only allows a patient to alert a participating ER that a patient is in route to the participating ER, but also can transmit PHI data and/or PHI profile to the participating ER so that the patient can register with a participating ER prior to arrival to the participating ER. The alert ER function effectively eliminates the time that would otherwise be necessary to register at the ER upon arrival to the ER. Therefore, the alert ER function greatly streamlines the registration process at participating ERs and allows the patient to receive emergency medical care quicker.

In another embodiment of the alert ER function, participating ERs may gain additional benefits. It is well-known in the art that ERs currently have a system that displays the availability or non-availability of ER rooms/beds (a/k/a ER resources) in real-time for purposes of organizing logistics with respect to patients currently at the ER—including registered patients waiting in the waiting room of the ER and registered patients currently occupied in an ER room/bed. With the added benefit of the alert ER function, a participating ER is also able to monitor incoming patients who are in route to the participating ER in real-time. This provides a great advantage because it allows the participating ER to better coordinate logistics (e.g. preparing ER rooms/beds, medical supplies, paging ER doctors, nurses, and other staff on their availability) in receiving patients who are on the way to the participating ER. Thus, the alert ER function creates a “virtual” waiting room of patients who are in route to the ER. Such added benefit is important for the participating ER from a logistics standpoint to better serve its patients in an efficient manner.

The present invention is also directed to a method of providing a patient's PHI data and/or PHI profile to a healthcare provider facility, without the use of readable scanning codes, such as QR codes. Rather than relying on readable scanning codes and scanners to extract information from the PHI data and/or PHI profile, this method provides for the display of PHI data and/or PHI profile in a human-readable form (i.e. in text form) on a mobile device, without the aid of any extraneous devices such as scanners. This method of providing PHI data and/or PHI profile to a healthcare provider facility in a human-readable form is beneficial in situations where the patient is unable to provide a readable scanning code to the healthcare provider facility, where the healthcare provider facility does not have the scanning equipment to scan a readable scanning code to obtain registration data, where such scanning equipment is broken, or just as a matter of convenience. The PHI data and/or PHI profile in a human-readable form can then be used by the patient or the healthcare provider facility staff to fill out any necessary paperwork by hand to allow the patient to register with the healthcare provider facility. Further, PHI data and/or PHI profile in a human-readable form can be used to answer questions from healthcare provider facility staff during patient registration or during a medical examination. Alternatively, the PHI data and/or PHI profile in a human-readable form can also be used for any other purpose required by the healthcare facility to better register or provide treatment to the patient.

In this embodiment, the method requires providing a secure, member-accessible online information storage database system for online storing of the patient's PHI data, providing a data security level to secure the PHI data, providing a secure web-based interface portal for a patient to register to become a member of the online information database storage system, establishing a secure patient member account for each patient, creating, via direct patient interface through the web-based interface portal, a secure, unique patient PHI profile stored within the online information storage database system, wherein only the patient (or the patient's authorized representative) may add to, subtract from, or otherwise modify, update or edit the PHI profile, and other PHI data contained in the PHI profile. The method further requires a device, preferably a mobile device, such as a smart phone, mobile, phone, or tablet, to display the PHI data on the screen of such device in a human-readable form so that the PHI data can be reviewed by healthcare facility provider staff without the aid of any extraneous scanners, readers, or other devices.

How the System Works for the Consumer.

When an emergency happens, people need quick and decisive action. The PHI database service provider uses, e.g, smart phone technology or other mobile electronic devices, that gives the patient and/or Emergency Workers fast and easy access to the patient's important medical profile stored online. A QR code is generated after the patient's online medical profile is created. This code contains medical profile information. This code conveniently placed on wallet-sized cards, stickers, key chains, jewelry, stickers and the like that can be placed in an easily accessible location, or can also be displayed on the patient's smart phone or other portable computing device. Emergency personnel (or other hospital facility personnel) can use any smart phone with a QR reader to scan the code and within an instant have access to the member's medical profile to help guide them in treatment. All smart phones have Free QR readers that can be downloaded by Emergency Workers which helps to streamline a person's emergency care. Overall a person gets medical care that's done quickly and more accurately than ever before. In addition, with the alert ER function made available through the web-based interface portal, a patient is able to alert and register with a participating ER even prior to arrival to the ER (e.g. while patient is in route to the ER or about to be in route to the ER) and provide the patient's PHI data from a remote location. The alert ER function eliminates delays that would otherwise be present if registration were only allowed while at the ER. The ability to electronically register with a participating ER and alert the ER of the patient's arrival, and also submit PHI data, will greatly improve the ER's logistics, resulting in faster registrations, less waiting time in the ER by patients, and faster medical care.

How the System Works for Emergency Personnel.

The Emergency Personnel find the person's QR code on them (on a wallet card, keychain, or other item). They scan it with a smart phone. They are given instant access to all of the person's important medical information which they may need in order to save the person's life.

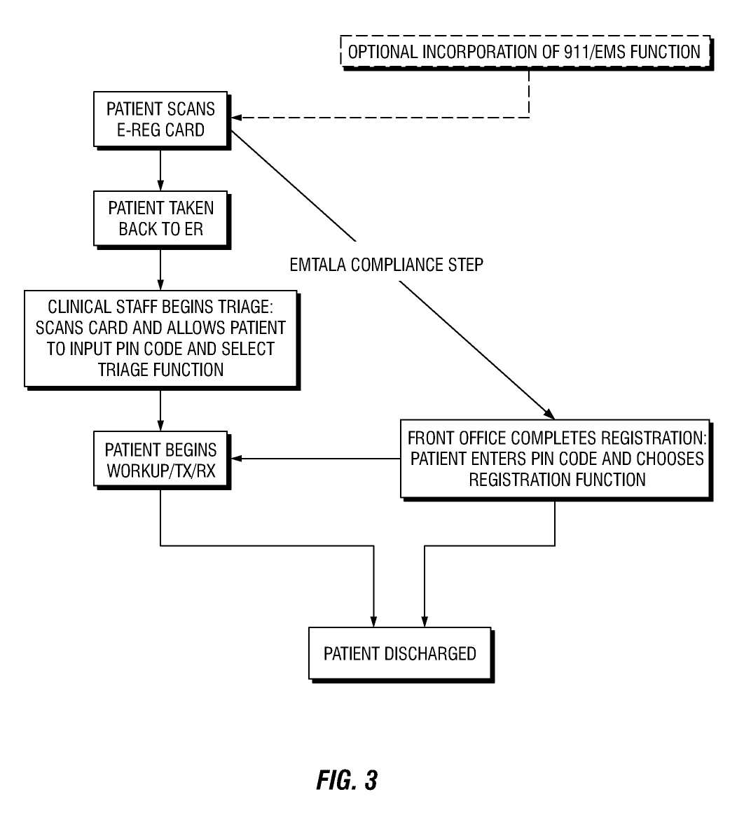

Referring to FIG. 3, there is shown a process flow diagram for the ER/ED patient E-Registration process. In this process, the patient has already obtained en E-registration card containing the patient's unique QR code. Upon entering the ER/ED, the patient scans his/her card. As a first step in the scanning process, to ensure compliance with the EMTALA, no insurance info is revealed as a result of the initial scan (but can be revealed in a second scan. The patient is then taken back to the ER. When the patient is back in the clinical area of the ER, the clinical staff begins triage, at which time the patient can then enter the PIN code and select the triage function. The patient will be prompted to either: (1) continue to full registration or (2) proceed with triage. Front office staff will choose registration and nurses will choose triage. The required care is delivered and the patient can be treated until discharged.

In one embodiment, the patient has the option of incorporating a 911/EMS functionality to the patient's E-registration card. This can be provided as part of the overall service/subscription options associated with the card. If a patient has enabled this option (e.g., via a subscription), EMS personnel can scan the QR code and a prompt will appear after the initial QR scan that asks whether the person scanning is a 911/EMS/paramedic or an ER/Hospital/Clinic staff. If the patient is ill and 911 is called, then the EMS/paramedic personnel will be able to choose appropriately, and vital healthcare information critical for potential lifesaving treatments and procedures will be displayed, e.g., code status, allergies, PMH, medications, etc. in the order that is appropriate for EMS/911 staff.

When a patient shows up in the ER, they will present their card containing their unique QR code. Facility staff scans the code and are taken to the website interface for the patient's PHI and the patient's personal records. The website will allow the facility staff to print out the patient's information on forms that mimic their facility's forms. In other embodiments, the website will preferably provide an HL-7 (health level 7) data standard interface so that data can be imported directly into the facility's own record system. Overall, a person obtains medical care that is done quickly and more accurately than ever before.

In preferred embodiments, the online storage facility and web interface portal system is provided and operated by a third party by subscription. In embodiments described herein, the patient may directly subscribe to the online PHI database system. In another embodiment of the present invention, the healthcare delivery facility first creates a healthcare delivery facility profile within the web-based PHI system database and then invites its patients to complete a database enrollment form through its facility profile via the portal so that when the patient next visits the healthcare delivery facility, the patient's registration information will be readily scannable on the facility's scanner and automatically populated into the facility's EHR. As such, in certain embodiments, the healthcare provider facility obtains the subscription to the system and in turn provides its patients with access to the system. In other embodiments, the patient obtains the subscription to the system.

The methodologies herein provide a complete and easy to use ER patient registration service based on QR codes. It represents a much needed solution to the issues that ERs and patients face—mainly, long wait times and inefficient patient registration processes. The system provides facilities an accurate and efficient solution that healthcare providers cannot find elsewhere.

The benefits of the present methodology accrue to several audiences: patients (and their family members), physicians, ER staff and facility management. Benefits include: Faster, more accurate patient registration; Assurance that patient data is correct; Shorter patient wait times; Reduced ER staff needs; Increased loyalty to the facility; Strengthening of the ER/ED's brand; and Facilitation of the triage process by instantaneously displaying patient medical information to the clinical staff. The system is also compliant with EMTALA and HIPAA.

The present invention provides advantages over the prior art systems. For example, with respect to the re-engineered and “lean” prior art processes, the present invention provides the following advantages: The system is easier to use—(don't have to enter information after initial patient signup); it is faster (“instantaneous”); it is more accurate; and it builds brand loyalty. With respect to the electronic solutions prior art processes, the present invention provides the following advantages: There is no need to set an appointment; and the patient proceeds to the ER immediately so that the patient does not risk the problem getting worse with the passage of time.

The present invention provides a unique solution based on QR technology. The QR technology provides accuracy, speed and safety. It is easy to use. Switching costs will be high. There currently exists a large market need, and multiple revenue streams are possible. The system builds patient loyalty and is very valuable to all concerned parties (patients, ERs and hospital administration).

This invention avoids the lengthy intake paperwork process experienced at the site of healthcare delivery when a patient arrives for such healthcare (regardless of whether the patient is a new patient or existing patient). This process also avoids the necessity of having the patient fill out paperwork by hand, and further avoids having the healthcare facility administrative staff manually enter such data into the information systems. This process also avoids having a nurse or doctor spend precious minutes with each patient to obtain this background information. Instead, having the information automatically imported into the system via such scanning of the QR code permits the healthcare provider to focus attention on more important matters with the patient (which can include, if desired or necessary, reviewing such history with the patient).

In one embodiment, there are two security levels for patients (users) to choose from. Security Level 1 is the default level where user information is easily obtained by scanning the QR code. Security Level 2 requires users to create a special pin code that will be required to input after scanning the QR code to permit access to the patient/user information.

In a preferred embodiment, the healthcare facility first signs up with web provider and then the healthcare facility provides an enrollment form (invitation) to patients to complete via the website interface/web provider so that on next visit to the provider, the information will be scannable on their intake scanners.

This invention can potentially also include having the patient (on his/her own) sign up with the web-based provider to create a somewhat universal health care intake registration profile (i.e., information that most, if not all healthcare facilities would request) so that the patient's QR code could be scannable at any healthcare facility regardless of whether that specific facility provided the form to (invited) the patient in the first instance. In this scenario, the QR code would need to be recognizable (upon scan) in any facilities' information system. It is envisioned that use of standardized interfacing conventions, such as the HL7 convention, will permit the patient's QR code to be read in any facility using this convention.

In another embodiment of the present invention, as a treating medical person (e.g., clinical staff, doctors and nurses in the ER, subspecialty doctors and primary care doctors) updates a patient's record regarding, e.g., the patient's medications, procedures, or conditions, this information is automatically registered in the healthcare facility's EHR system. This information can then in turn be automatically (via the same HL7 interfacing) updated into the cloud based database. The initial QR scanning pulls information down from the cloud but this functionality of the present invention sends information back up to the cloud to update the patient record.

Additionally, in another embodiment of the present invention, as a patient is discharged from the ER, the patient's prescriptions may be automatically and electronically faxed to the desired pharmacy of the patient's choice. In one embodiment, the patient can preselect a desired pharmacy during the registration process so that no prescription paper is needed. With this feature, the patient no longer has to physically carry the prescription and wait or come back to the pharmacy to get the prescribed medications. The prescription will be automatically sent so that there is little or no wait by the time the patient shows up at the pharmacy. This paperless process is an environmentally friendly process while also providing time savings for the patient.

Also, in another embodiment, at the time of the sign up, a patient may choose various frequencies of reminders to update their information in the database (e.g., their medications, surgeries, address, phone and other contact information, insurance information, etc. The patient can select any desired reminder interval, such as, every 3 months, every 6 months, etc. where, e.g., the default reminder value is set to every 9 months. The reminders can take the form of email reminders automatically sent to the patient to remind the patient to update his or her records. The form of the reminder could take other forms, such as by regular mail or automated telephonic message, or the like.

Furthermore, another embodiment of the invention includes the use of an automatic service survey being sent out to the patient. For example, after every ER visit, an automatically generated survey is sent to the patient. Email reminders can be employed to remind the patient to participate in the survey. Surveys are important tools that all hospitals and healthcare institutions use to continually improve their quality and significant amounts of money are spent to seek to have these patients fill out and return the surveys after their visit to the ER. The present invention automates this system by auto-generating the survey, sending it to the patient, and sending reminders to the patient to complete the survey.

The benefits to the present invention include that it is easy to use—the patient just enters his/her information within the database provider's secure user profile section. The patient controls all content put in his/her profile. The system is safe and secure to use. The patient's information is protected and the patient allows access only to the people who need it the most . . . those working to save the patient's life (in an emergency) or those requiring the patient's PHI for intake registration into a healthcare facility. This system prevents errors because the medical information provided to the health care provider through this system will help Emergency Personnel make the right treatment decisions, and will assist the healthcare provider facility in the patient intake process. This system also prevents delays in the patient care by providing quick access to the patient's critical information to speed up the patient intake process or to speed up the delivery of life-saving emergency care.

With the alert ER function, a participating ER is able to monitor and manage a “virtual” waiting room in that the participating ER will be notified or alerted of a patient who is in route to the ER. By knowing in advance which patient and the number of patients who are anticipated to arrive to the ER, the ER can better prepare logistics in patient intake registration and patient emergency medical care. The alert ER function provides a method for a patient to upload PHI data and/or PHI profile to the participating ER, notify the ER of the patient's chief complaint, age, gender, and estimated time of arrival. This information streamlines the logistics of patient intake registration and assists in the logistics in preparing the patient to receive emergency medical care at a participating ER. In another embodiment, this may be performed in an EMTALA compliant process where patient's payor or insurance status will be withheld until after the patient has received a medical screening exam.

All references referred to herein are incorporated herein by reference. While the apparatus, systems and methods of this invention have been described in terms of preferred or illustrative embodiments, it will be apparent to those of skill in the art that variations may be applied to the process and system described herein without departing from the concept and scope of the invention. All such similar substitutes and modifications apparent to those skilled in the art are deemed to be within the scope and concept of the invention. Those skilled in the art will recognize that the method and apparatus of the present invention has many applications, and that the present invention is not limited to the representative examples disclosed herein. Moreover, the scope of the present invention covers conventionally known variations and modifications to the system components described herein, as would be known by those skilled in the art.

### U.S. PATENT REFERENCES

| | | |
|---|---|---|
| 5,499,293 | Mar. 12, 1996 | Behram et al. |
| 6,082,776 | Jul. 04, 2000 | Feinberg |

### U.S. PATENT APPLICATION PUBLICATIONS

| | | |
|---|---|---|
| 2009/0177495 | Jul. 09, 2009 | Abousy et al. |
| 2006/0106646 | May 18, 2006 | Squilla et al. |
| 2007/0290028 | Dec. 20, 2007 | Fox et al. |
| 2001/0048027 | Dec. 06, 2001 | Walsh |

### NON-PATENT LITERATURE DOCUMENTS

S.M.A.R.T. Association, Inc., “SMART Cards and Healthcare: The Time Has Come”, http://www.Smartassociation.com/solution/smartcard.cfm, 2009.
Grogan, D., “Smart Cards in Healthcare: A Logical Evolution”, SMART, Apr. 16, 2007, http://www.Smartassociation.com/solution/smart-card-white-paper-online.pdf.
Neame, R., “Smart cards—the key to trustworthy health information systems”, BMJ, 1997; 314:573; http://www.bmj.com/content/314/7080/573#alternate.
Xiao, C. and Yu, A., “Medical Smart Card System for Patient Record Management”, http://step.berkeley.edu/White_Paper/Xiao_Yu.pdf, University of California, Berkeley.
Hansen, M., “Smart Card Technology and Healthcare Information: A Dynamic Duo”, University of San Francisco, http://repository.usfca.edu/cgi/viewcontent.cgi?article=1009&context=nursing_fac, Jan. 1, 2008.
Rabin, Roni Caryn, “Fewer Emergency Rooms Available as Need Rises”, New York Times; May 17, 2011), http://www.nytimes.com/2011/05/18/health/18hospital.html?_r=0.
Hsia, R. Y., Kellermann, A. L., and Shen, Y. “Factors Associated With Closures of Emergency Departments in the United States”, Journal of the American Medical Association, May 18, 2011.
Gindi, R. M, Cohen, R. A., and Kirzinger, W. K., “Emergency Room Use Among Adults Aged 18-64: Early Release of Estimates From The National Health Interview Survey, January-June 2011”, CDC, May 2012. http://www.cdc.gov/nchs/data/nhis/earlyrelease/emergency_room_use_january-june_{—}2011.pdf.
Armour, S., “ER Concierge Services at Hospitals Boost Bottom Lines”, Bloomberg News, Nov. 26, 2012, http://www.bloomberg.com/news/2012-11-21/er-concierge-services-at-hospitals-boost-bottom-lines.html,
Henry J. Kaiser Family Foundation, “Hospital Emergency Room Visits per 1,000 Population, 2010”, http://www.statehealthfacts.org/comparemaptable. jsp?yr=138&typ=1&ind=388&cat=8&sub=217&sortc=1&o=a&print=1.
Henry J. Kaiser Family Foundation, “Total Hospitals, 2010”, http://www.statehealthfacts.org/comparemaptable.jsp?ind=382&cat=8&print=1.
CDC, “Summary of Emergency Department Visits in U.S.”, http://www.cdc.gov/nchs/fastats/ervisits.htm.
CDC, “National Hospital Ambulatory Medical Care Survey: 2009 Emergency Department Summary Tables, http://www.cdc.gov/nchs/data/ahcd/nhamcs_emergency/2009_ed_web_tables.pdf.
Ayers, A., “Emerging Business Models: Freestanding Emergency Rooms”, http://www.ucaoa.org/docs/Article_Freestanding.pdf.
Barnett, E. C., “The Problem with Private Emergency Rooms”, http://www.seattlemet.com/news-and-profiles/publicola/articles/the-problem-with-private-emergency-rooms, Dec. 27, 2011.
INQUICKER, LLC (Nashville, Tenn.) (inquicker.com) webpages regarding the InQuicker system.
ERMedStat (Maryville, Tenn.) (ermedstat.com) webpages regarding the ERMedStat system.
MyInfo911.com (Palm Coast, Fla.) webpages regarding the MyInfo911 system.
Lifesquare, Inc. (Menlo Park, Calif.) (lifesquare.com) webpages regarding the Lifesquare system.
ScanMedQr.com (Oklahoma City, Okla.) webpages regarding the ScanMed QR system.
Garan Lucow Miller, P. C. “emtala.com” webpages about EMTALA (www. emtala.com).

We claim:

1. A method of streamlining intake registration of a patient at a healthcare provider facility comprising the steps of:
a. providing a secure, member-accessible online information storage database system for online storing of the patient's private health information (PHI) data;
b. providing a data security level to secure the PHI data;
c. providing a secure web-based interface portal for the patient to register to become a member of the online information storage database system;
d. establishing a secure patient member account for each patient;
e. creating, via direct patient interface through the web-based interface portal, a secure, unique patient PHI profile stored within the online information storage database system wherein only the patient may add to, subtract from or otherwise modify, update or edit the PHI profile, and other PHI data contained in the PHI profile;
f. creating a unique, secure, readable scanning code that will permit access to the PHI profile;
g. placing the readable scanning code on media that may be carried by the patient;
h. providing a scanner at the healthcare provider facility for scanning and reading the readable scanning code, the scanner being interfaced with at least one electronic health record (EHR) system, comprising EHR fields, at the healthcare provider facility;
i. scanning the readable scanning code on the scanner;
j. downloading information from the PHI data required for the intake registration of the patient to obtain scanned registration data;
k. interfacing the scanner at the healthcare provider facility with any other desired EHR systems at the healthcare provider facility; and
l. automatically populating the healthcare provider facility's EHR systems with the scanned registration data.

2. The method of claim 1 wherein the healthcare provider facility is selected from the group consisting of emergency rooms, emergency departments, freestanding emergency centers, walk-in medical facilities, hospital intakes, specialty hospitals, hospital systems, medical and dental clinics, health clinics, doctor's offices, dentist's offices, medical labs, emergency response vehicles, and other health care provider locations.

3. The method of claim 1 wherein the readable scanning code is a Quick Response (QR) code and the scanner is a QR reader/scanner.

4. The method of claim 3 wherein the patient's QR code is read by a QR scanner, a smartphone, or a mobile phone with a camera and QR code reader software.

5. The method of claim 1 wherein the readable scanning code is selected from the group consisting of a Quick Response (QR) code, a bar code, a matrix bar-code, a two-dimensional code, a radio-frequency identification (RFID) code, a near field communications (NFC) code or the like or combinations thereof.

6. The method of claim 1 wherein the online information storage database system is maintained on one or more networked servers.

7. The method of claim 1 wherein the online information storage database system is maintained in a cloud-based storage system.

8. The method of claim 1 wherein the media containing the readable scanning code is selected from the group consisting of wallet-sized cards, pendants, key chains, bracelets, or stickers displaying the readable scanning code.

9. The method of claim 1 wherein the media containing the readable scanning code is an electronically displayable graphic image capable of being displayed on a screen of the patient's smart phone device, tablet device, PC, or the like, wherein a suitable mobile website or mobile smart phone, tablet, or PC application, is first installed onto the patient's device to permit the patient's device to display the QR code and to permit access to the patient's member account to input, read, and edit the PHI data.

10. The method of claim 1 wherein the patient scans the readable scanning code on the scanner.

11. The method of claim 1 wherein the patient's guardian scans the readable scanning code on the scanner.

12. The method of claim 1 wherein medical personnel scan the readable scanning code on the scanner.

13. The method of claim 1 wherein multiple PHI data security levels are available to the patient.

14. The method of claim 13 wherein two sequential PHI data security levels are provided for the patient to choose from, the first security level being the default and permitting the PHI data to be obtained by scanning the readable scanning code, the second security level requiring the steps of having the patient first create a special pin code as part of the step of creating the PHI profile, and then inputting the pin code after scanning the readable scanning code at the healthcare provider facility to enable the healthcare provider facility access to additional PHI data.

15. The method of claim 1 wherein the step of downloading information of the PHI data upon scanning the readable scanning code at the healthcare provider facility is limited in content to the EHR fields required for intake registration at the facility, and does not contain any information about payor or insurance coverage.

16. The method of claim 1 wherein the security level set by the patient will always permit the healthcare provider facility to access a minimum PHI data required for patient intake registration and a patient medical screening exam, but will permit the patient to protect additional patient protected PHI data requiring further patient authorization to obtain the additional patient protected PHI data.

17. The method of claim 1 wherein the online information storage database system is compliant with requirements of the Emergency Medical Treatment and Active Labor Act (EMTALA) and the Health Insurance Portability and Accountability Act (HIPAA).

18. The method of claim 1 wherein interfacing the scanner at the healthcare provider facility with any other desired EHR system at the facility is accomplished via standardized data interface convention.

19. The method of claim 18 wherein the standardized interface convention is the Health Level 7 (HL-7) convention.

20. The method of claim 1 wherein the healthcare provider facility first creates a healthcare provider facility profile within the web-based interface portal online information storage database system and then invites the patient to complete a database enrollment form through its facility profile via the web-based interface portal so that when the patient next visits the healthcare provider facility, the patient's PHI data will be readily scannable on the facility's scanner and automatically populated into the facility's EHR system.

21. The method of claim 1 wherein the online information storage database system and web-based interface portal is provided and operated by a third party by a subscription to the online storage information database system.

22. The method of claim 21 wherein the healthcare provider facility obtains the subscription to the online storage information database system and in turn provides the patients with access to the online storage information database system.

23. The method of claim 21 wherein the patient obtains the subscription to the online information storage database system.

24. The method of claim 1 wherein the readable scanning code is universally readable, via scanner, into any EHR system at any healthcare provider facility.

25. The method of claim 1 comprising the further step of providing the healthcare provider facility personnel with access to the PHI data from the EHR system.

26. The method of claim 1 wherein the web-based interface portal security comprises HTTPS protocols, hypertext transfer protocol secure, secure socket layers, transport layer security, TPL, PHP secure sessions, data encryption algorithms, personal pin codes, and patient-created password that is protected by an MD5 encrypted password hashing algorithm.

27. The method of claim 1 comprising the additional step of providing a mechanism for remotely deactivating the readable scanning code.

28. The method of claim 1 further comprising the option of providing the patient with the ability to set the data security level of the readable scanning code to permit emergency workers to gain access to the PHI data upon scanning the readable scanning code or upon calling a call-in center.

29. The method of claim 1 providing for a web-based or a telephone call-in center capable of providing pin codes or any additional instructions on usage of the readable scanning code, including any 911 functions.

30. The method of claim 1 wherein the patient preselects a desired pharmacy to fill prescriptions and the prescriptions are automatically and electronically transmitted to the desired pharmacy.

31. The method of claim 1 wherein a survey is automatically generated, the survey is sent to the patient, and an email reminder is sent to the patient to request the patient to complete the survey.

32. A method of streamlining intake registration of a patient with a healthcare provider facility, comprising the steps of:
a. providing a secure, member-accessible online information storage database system for online storing of the patient's private health information (PHI) data;
b. providing a data security level to secure the PHI data;
c. providing a secure web-based interface portal for the patient to register to become a member of the online information storage database system;
d. establishing a secure patient member account for the patient;
e. creating, via direct patient interface through the web-based interface portal, a secure, unique patient PHI profile stored within the online information storage database system wherein only the patient may add to, subtract from or otherwise modify, update or edit the PHI profile, and other PHI data contained in the PHI profile;
f. uploading the PHI data required for the intake registration of the patient to the healthcare provider facility via the web-based interface portal, wherein the healthcare provider facility is capable of receiving the PHI data; and
g. automatically populating the healthcare provider facility's electronic health record (EHR) systems with the PHI data.

33. The method of claim 32 wherein the online information storage database system is compliant with requirements of the Emergency Medical Treatment and Active Labor Act (EMTALA) and the Health Insurance Portability and Accountability Act (HIPAA).

34. The method of claim 32 wherein the web-based interface portal further comprises an alert ER function to allow the patient to alert a participating ER that the patient is in route to the participating ER.

35. The method of claim 34 wherein the alert ER function has the further capability of allowing the patient to upload information comprising the patient's current chief complaint, gender, age, and estimated time of arrival to the participating ER.

36. The method of claim 34 wherein the alert ER function has the further capability of assessing whether the patient's current chief complaint is a life-threatening emergency, and if so, directs the patient to immediately dial 911 emergency medical services.

37. A method of providing a patient's private health information (PHI) data to a healthcare provider facility comprising the steps of:
a. providing a secure, member-accessible online information storage database system for online storing of the PHI data;
b. providing a data security level to secure the PHI data;
c. providing a secure web-based interface portal for the patient to register to become a member of the online information storage database system;
d. establishing a secure patient member account for the patient;
e. creating, via direct patient interface through the web-based interface portal, a secure, unique patient PHI profile stored within the online information storage database system wherein only the patient may add to, subtract from or otherwise modify, update or edit the PHI profile, and other PHI data contained in the PHI profile; and
f. providing a mobile device to display the PHI data in a human-readable format so that the PHI data can be reviewed by a healthcare provider facility staff.

38. The method of claim 37 wherein the PHI data in a human-readable format is used to register the patient with the healthcare provider facility.
